(19) United States
(12) Patent Application Publication
(10) Pub. No.: US 2020/0211395 A1
(43) Pub. Date: Jul. 2, 2020

(54) Method and Device for Operating a Driver Assistance System, and Driver Assistance System and Motor Vehicle

(71) Applicant: Audi AG, Ingolstadt (DE)

(72) Inventors: Christian FEIST, Ingolstadt (DE); Jörn THIELECKE, Erlangen (DE); Florian PARTICKE, Spardorf (DE); Lucila PATINO-STUDENCKI, Nürnberg (DE)

(73) Assignee: Audi AG, Ingolstadt (DE)

(21) Appl. No.: 16/632,610

(22) PCT Filed: Sep. 20, 2018
(86) PCT No.: PCT/EP2018/075500

§ 371 Date: Jan. 21, 2020

(30) Foreign Application Priority Data
Sep. 26, 2017 (DE) 10 2017 217 056.5

(51) Int. Cl. G08G 1/16; G06K 9/62; G06K 9/00

(52) U.S. Cl. CPC G08G 1/166; B60W 30/0956; G06K 9/00805; G06K 9/628

(57) ABSTRACT

An approach is described for operating a driver assistance system that is used to predict a movement of at least one living object in the surroundings (17) of the motor vehicle. The approach includes storing motion models characterizing movements for a combination of object classes; receiving measurement data relating to the surroundings; recognizing the living object and at least one other object in the surroundings and determining a position of the objects in relation to each other; identifying the object classes of the known objects; for the living object developing an equation of motion at least according to the respective position of the living object in relation to the other object as well as the motion model stored for the combination of the identified object classes; and predicting the movement on the basis of the equation of motion; and operating the driver assistance system taking into account the predicted movement.

### TECHNICAL FIELD

The present disclosure relates to a method for operating a driver assistance system of a motor vehicle, in which a movement of at least one living object in the surroundings of the motor vehicle is predicted. Furthermore, the present disclosure relates to a device for carrying out the method, and a driver assistance system and a motor vehicle.

### BACKGROUND

Today's motor vehicles are often equipped with driver assistance systems, such as a navigation system or cruise control. Some of these driver assistance systems are also designed to protect vehicle occupants and other road users. These can assist a driver of the motor vehicle in certain dangerous situations. For example, a collision warning device usually recognizes the distance, and to a certain extent also the speed difference, to other vehicles by means of a camera or via a radar or lidar sensor, and warns the driver if the danger of a collision is detected. Furthermore, there are driver assistance systems which are designed to drive the motor vehicle at least partially autonomously or in certain cases even autonomously. Currently, the deployment scenarios of autonomous driving are very limited, for example, parking or driving situations with very well-defined conditions such as on highways. The more autonomous a motor vehicle is intended to be, the higher are the requirements for detecting and monitoring the surroundings of the motor vehicle. The motor vehicle must, by means of sensor units, detect the surroundings as accurately as possible to recognize objects in the surroundings. The more accurately the motor vehicle “knows” the surroundings, the better, for example, accidents can be avoided.

For example, DE 10 2014 215 372 A1 discloses a driver assistance system of a motor vehicle having a targeted environment camera and an image processing unit, which is arranged for processing the image data of the environment camera. Furthermore, the driver assistance system comprises an image evaluation unit designed to evaluate the processed image data.

### BRIEF DESCRIPTION OF DRAWINGS/FIGURES

FIG. 1 illustrates a schematic plan view of a motor vehicle with a driver assistance system and a device, in accordance with some embodiments.

FIG. 2 illustrates a schematic diagram of an interaction of individual components of the method in a monitoring of the living object, in accordance with some embodiments.

### DETAILED DESCRIPTION

The object of the present present disclosure is to provide a way to further reduce the risk of accidents.

The object is achieved by the subject matters of the independent claims. Advantageous developments are described by the dependent claims, the subsequent description and the drawings.

The present disclosure is based on the findings that while large and/or static objects are well recognized in the prior art, the recognition and monitoring of dynamic objects such as pedestrians are difficult. In particular, the resulting positive consequences in the operation of a driver assistance system are not yet exhausted. Thus, if the movement of pedestrians can be predicted and taken into account when operating a driver assistance system, the risk of accidents can be significantly reduced.

In order to be able to perform the monitoring of dynamic, living objects, such as pedestrians, as well as possible, it is helpful if a prediction of their movement is made, that is, if their future behavior can be estimated. For static surveillance cameras, there are already approaches for monitoring. For example, Helbing developed a so-called “social force model” for a simulation of the movements of pedestrians as described in HELBING, Dirk; MOLNAR, Peter. Social force model for pedestrian dynamics. Physical review E, 1995, 51. Jg., No. 5, p. 4282. In this model, every pedestrian is in a force field, from which adding up the forces results in a total force, which acts on the pedestrian. This model has proven itself in the simulation of crowds, which is why it has been used in the past for the tracking of crowds.

Presently, implementations of the “social force model” are used, for example, for monitoring pedestrians using static surveillance cameras, but not in driver assistance systems. K. Yamaguchi, A. C. Berg, L. E. Ortiz, T. L. Berg, “Who are you with and where are you going?” in Computer Vision and Pattern Recognition (CVPR), 2011 IEEE Conference on. IEEE, 2011, pp. 1345-1352 or S. Yi, H. Li, X. Wang, “Understanding pedestrian behaviors from stationary crowd groups,” in Proceedings of the IEEE Conference on Computer Vision and Pattern Recognition, 2015, pp. 3488-3496 provides examples for monitoring pedestrians using static surveillance cameras.

The present disclosure is based on the fact that the findings can be used in predicting the movement of crowds based on the movement of individual people and thus can be exploited in the operation of a driver assistance system.

In some embodiments, a method for operating a driver assistance system of a motor vehicle is disclosed. The driver assistance system predicts a movement of at least one living object, in particular of a pedestrian, in the surroundings of the motor vehicle. In a step a) of the method, motion models are stored, wherein a respective motion model describes at least one change of the movement of the living object that depends on another object. The living object and the at least one other object each belong to an object class. The motion models are stored for combinations of the object classes. In a step b) of the method, measurement data relating to the surroundings of the motor vehicle are received. In a step c) of the method, the at least one living object and the at least one other object in the surroundings of the motor vehicle are recognized, and a position of the objects in relation to one another is determined on the basis of the received measurement data. In a step d) of the method, the object classes of the detected objects are identified. In a step e) of the method, for the at least one detected living object, an equation of motion of the living object is developed in a first sub-step e). In this case, the equation of motion depends at least on the respective position of the living object in relation to the at least one other object and the at least one motion model stored for the combination of the object classes of the living object and the at least one other object identified in step d). In a second sub-step e), a movement of the living object is predicted based on the equation of motion developed in the first sub-step e). In a step f) of the method, the driver assistance system is operated by incorporating the movement of the at least one living object predicted in step e); in other words, the prediction of the movement influences a behavior of the driver assistance system. Thus, for example, in situations in which it is predicted by means of the method according to the invention that a moving pedestrian will collide with the moving motor vehicle, brake assistance and/or course correction in at least partially autonomous driving can for example take place.

In some embodiments, at least one living object is being understood as a pedestrian; for example, a distinction can be made between a child, an adult person and an elderly person. Also, for example, a person with a physical disability that limits the mobility of the person may be considered. By way of non-limiting example, it may be considered whether, for example, the child is traveling on a scooter and/or the adult is riding a bicycle or the like. Any combinations are possible. Furthermore, a living object may be an animal, such as a dog.

In some embodiments, the at least one other object may be one of the previously mentioned objects, i.e., a living object and/or a group of living objects or another object such as a motor vehicle, a ball, a robot, an ATM and/or an entrance door. In particular, in the case of the other object, a dynamic object is meant, in other words, an object which can move itself. However, the other object may be a semi-static or a static object. Each of the mentioned objects can be assigned to or classified in an object class. Examples of object classes are: “adult pedestrian,” “dog” or “motor vehicle.”

In some embodiments, the motion models stored in step a) contain at least information as to how the living object reacts to one of the other objects, that is, what influence the respective other object exerts or can exert on the movement of the living object. In the image of the “social force model” spoken, which force the other object exerts on the living object. By way of non-limiting example, the motion model characterizes the influence of an object, for example, a dog, on the living object, for example, a pedestrian. For this purpose, respective motion models for combinations are stored, for example, for the combination “pedestrian-dog.” In short, in step a), a storage of motion models for combinations of an object class of at least one living object and one object class of at least one other object is satisfied, wherein the motion models each describe the movement change of the living object assigned to the object class of the respective motion model based on the other object associated with the object class of the respective motion model.

In some embodiments, information can be stored in the respective motion model, which specifies, for example, certain limit values in the movement of the living object, such as parameters describing a maximum speed of the living object and/or a maximum possible braking deceleration and/or free or force-free movement of the living object. Here, free or force-free is to be understood as meaning that there is no influence on the movement of the living object by another object, that is to say, that no force acts on the living object by another object. This additional information characterizing the movement of the living object can be summarized as the dynamics of the living object. This dynamic is influenced by the at least one other object. The influence on the living object, for example on the pedestrian, is based on the knowledge of the living object via the respective other object, and thus serves for the pedestrian as a respective source of information influencing its dynamics.

In some embodiments, by means of the stored motion models, the respective information source can be modeled and parameterized individually, i.e., without mutual influence. By way of non-limiting example, a separation of the dynamics and the information sources takes place, which can be designated as a boundary condition of the method as described herein. An intention is attributed to the living object which characterizes or influences its movement, for example a destination to be reached. There is a parameterization of the dynamics and the at least one other information source, that is, the influence of the at least one other object by the motion model, resulting particularly advantageously in few parameters. This is advantageous in step e) of the method as described herein for developing the equation of motion, because the method is thereby particularly easily scalable, for example.

In some embodiments, in step b) of the method, measurement data relating to the surroundings of the motor vehicle are received. This or these may be, for example, one or more images, in particular temporally successive images, of at least one camera.

In some embodiments, in step c), for example by at least one suitable algorithm, objects in the measurement data are detected, for example on at least one image. In this case, the object, in particular the at least one living object and a position of the object in the surroundings of the motor vehicle is detected during the recognition. For developing an equation of motion in step e), which takes into account a change in the movement of the living object due to at least one other object, at least one other object should be recognized. Upon recognition of this other object, its position is detected. For describing an influence on the movement of the living object through the other object by means of the equation of motion in step e) particularly, a position of the objects in relation to one another is determined from the detected positions.

In some embodiments, the identification of the object classes of the detected objects takes place in step d). For this purpose, for example, by means of a suitable algorithm designed as a classifier, a comparison of the recognized objects or features of the recognized objects is performed with the characteristic features of an object class.

In some embodiments, in step e), the equation of motion is developed in a first sub-step for the at least one detected living object whose movement is to be monitored. This takes place as a function of the respective position of the living object in relation to the at least one other object and the motion models stored for the combination of the object classes of the objects.

In some embodiments, by way of non-limiting example, in a second sub-step of step e), the movement of the living object is predicted on the basis of the developed equation of motion. Particularly dynamic, direction of movement is output at a speed and/or acceleration.

In some embodiments, the respective motion model is developed from empirical values of previous observations and does not have to have a general validity. In reality, pedestrians may occasionally walk towards a dog, although the motion model predicts that pedestrians will generally stay away from a dog. Therefore, the respective motion model can additionally contain a probability for the occurrence of the reaction of the living object to the other object. By means of this probability, a respective weighting factor can be taken into account in the equation of motion so that the respective motion models acting on the movement are detected as a function of their statistical appearance.

In some embodiments, in step f) of the method, the driver assistance system is operated taking into account the movement of the at least one living object predicted in step e). As a result, the driver assistance system can be operated particularly safely, for example, and collisions of the motor vehicle with the recognized objects can be avoided. By means of the method according to the invention, the equation of motion and thus the prediction of the movement of the living object, in particular of a pedestrian, is particularly advantageously possible and the driver assistance system can be operated particularly advantageously.

Thus, the method according to the embodiments as described herein provides the advantage that for the living object its own dynamics is taken into account, which dynamics is influenced by the different sources of information. The method is particularly efficient and scalable, since, for example, the respective information source is individually modeled and parameterized. Particularly in contrast to the prior art, by including the information sources for an intention, that is to say a desired direction of movement of the living object, the number of parameters is minimized and represented in an understandable manner. Furthermore, the dynamics are calculated independently of respective other information sources, whereby the method is scalable, in particular with regard to the information sources or motion models to be used. By choosing the right motion models, a particularly good parameterization is possible, which leads in particular to an improved overall result in the prediction of the movement of the living object. A further advantage of the method is that a prediction of the movement of the living object is already possible with a single set of measurement data characterizing the surroundings of the motor vehicle, for example an image at a first point in time.

In some embodiments, the equation of motion in step e) is additionally determined as a function of a respective object orientation, with this being determined in step c). Object orientation is understood to mean an orientation of the object in space or a spatial orientation of the object in the surroundings. Based on the object orientation of the living object, its intention can be estimated very well by the method. By incorporating the object orientation, the equation of motion can be changed in such a way that a particularly good prediction of the movement of the living object is possible. If, for example, it is detected in step c) that the living object, for example the pedestrian, looks in a direction in which the other object, for example the dog, is not visible, the dog has no influence on the movement of the pedestrian. By way of non-limiting example, the pedestrian lacks an information source that could influence its dynamics. The at least one further recognized object, which is located in a viewing area or field of view associated with the living object, serves as an information source, on the basis of which the living object can change its dynamics. The respective motion models stored for the objects known to the living object are included in the equation of motion. Motion models of objects not known by the living object can be discarded. In addition, the object orientation of the other object may also play a role in determining the equation of motion.

In some embodiments of the method, the equation of motion in step e) is additionally developed as a function of a respective direction of movement and/or speed and/or acceleration of the living object and/or of the at least one other object. For this purpose, the measured data from the respective positions of the detected objects determined at a first point in time are compared in relation to the respective positions determined from measurement data at at least one further point in time, whereby a respective movement direction and/or a respective speed and/or a respective acceleration of the respective object is determined. In addition to the respective position, the respective particular object orientation can be used, whereby the determination of the respective direction of movement and/or speed and/or acceleration can be improved. By including the determined directions of movement and/or speeds and/or accelerations on the basis of measured data from at least two different points in time, a refinement of the equation of motion is possible, as a result of which the prediction of the movement becomes particularly accurate.

In some embodiments, the respective motion model is described by means of a respective potential field, which describes in particular a scalar field of a potential. By way of non-limiting example, the influence of the other object on the living object is determined or described by a potential field or a potential, which may, for example, have an attractive or repulsive character with respect to the living object. By using a potential field, the respective motion model can be incorporated in a particularly simple manner, i.e. in an easily calculable manner for example, into the equation of motion.

In some embodiments, a respective gradient is formed from the respective potential field and the equation of motion is developed as a function of at least the respective gradient. By means of the respective gradient, for example, a respective acceleration vector of the respective potential field can be determined. The respective acceleration vector can be used particularly simply to form the equation of motion or to predict the movement. Depending on the selected models of movement, for example, if they are chosen analogously to the forces of the well-known “social force model,” the model can be generalized to a potential approach by using potential fields and gradients. For this purpose, a potential is calculated for each information source, i.e., all other objects that are perceived in particular by the living object. The respective acceleration vector can be determined from the potential field or the gradient of the respective potential field. For this purpose, the gradient of the respective potential field at the position of the living object is determined. The acceleration vectors and the movement predictable therefrom can thus be used as a so-called control variable in the monitoring, that is to say the tracking of the living object. The respective potential field can be definable or can be estimated, for example, using the findings of the “social force model.” By virtue of the potentials underlying the potential fields, a particularly simple parameterization of the dynamics of the living object and of the at least one other object of the information source takes place relative to an intention present by the living object. The intention is here the actual goal of the living object, which it wants to reach by means of its movement. Furthermore, a particularly simple separation of dynamics and information source is possible by the use of at least one potential field and the associated gradient.

In some embodiments, a further sub-step can be carried out in step e) of the method. In this further sub-step, the equation of motion is compared with a map of the surroundings of the motor vehicle and if the motion predicted in the second sub-step of step e) is recognized as not executable due to the map information by means of the equation of motion determined in the first sub-set of step e), the equation of motion and the prediction of the motion is corrected based on the map information. By way of non-limiting example, a map comparison takes place, wherein information may be contained in the map, which cannot be detected by means of the measurement data or cannot be derived from the measurement data. For example, information about objects may be contained in the map, which objects are outside the range of at least one sensor unit detecting the measurement data or are obscured by a detected object. Such map information may include, for example, obstacles such as rivers and/or road closures and the like. Furthermore, for example, information about the above-mentioned ATM and/or, for example, sights that may be particularly attractive to the living object, may be included. As a result, for example, the intention of the living object can be particularly easily estimated. This information of the map can additionally be taken into account in the determination of the equation of motion or in the prediction. By comparing the predicted movement or the equation of motion with the map, the prediction can provide particularly good results.

In some embodiments, in the event that at least two other objects are detected and classified, a respective change of the respective movement of the respective other object due to a reciprocal interaction between the at least two other objects and the equation of motion of the at least one living object is taken into account. In this case, the interaction is determined from the respective stored motion model and the respective relative position. The living object which is at the smallest distance from the motor vehicle can be the object to be monitored. For example, if there are two other objects in the surroundings whose distance to the motor vehicle is greater, their mutual influence on the respective movement of the respective other object can be determined. These movements determined for the at least two other objects in particular in an additional manner can be taken into account in the determination of the equation of motion. For example, one of the two objects may be a child and the other object may be an adult. For each of these objects a movement can be predicted by the respective stored motion model by means of the method. Thus, the influence on the equation of motion of the living object by the at least two other objects can be taken into account in a particularly realistic manner and a particularly good prediction of the respective movement of the objects can be determined. This results in the advantage that the precision of the prediction of the at least one living object can be further increased. In addition, there is the possibility of combining a plurality of people into a group of people. If an object class which describes the movement model for or relative to a group of people is stored, the change of the movement due to a group of people can be recorded in the equation of motion. Groups of people can cause a different movement change of the pedestrian than a plurality of individuals. If this is taken into account, the prediction will be improved.

In some embodiments, the at least one other object is the motor vehicle itself. That is, the motor vehicle itself is taken into account as an influencing factor on the movement of the living object. The method knows the object class as well as the position and movement of the motor vehicle. This also results in an improved prediction of the movement of the living object. As a result, for example, an unnecessary braking maneuver can be avoided by the driver assistance system, since the motor vehicle usually acts repulsively on the living object, whereby the living object tries to maintain at least a minimum distance from the motor vehicle. Without the inclusion of the motor vehicle as an object, this information could not be taken into account in the equation of motion, whereby the driver assistance system obtains information that predicts a collision to be more likely, which could lead to the braking maneuver.

In some embodiments, a device for operating a driver assistance system of a motor vehicle is disclosed. The device associated with the driver assistance system can be connected to at least one sensor unit via at least one signal-transmitting interface. The device is designed to detect at least one living object and at least one other object in the surroundings of the motor vehicle and their respective object position on the basis of measurement data generated by the at least one sensor unit and received at the interface. The device is designed to divide the objects detected by the measurement data into object classes, wherein for a respective combination of an object class of the living object and the other object a respective motion model is stored in the device and/or can be retrieved therefrom. The respective motion model characterizes a movement change of an object of the object class of the living object on the basis of an object of the object class of the other object. The device is designed to develop an equation of motion of the at least one living object as a function of at least the motion model associated with the combination of the object classes and the object position of the living object and the at least one other object. Furthermore, the device is designed to predict the movement of the at least one living object based on the equation of motion and to provide the data characterizing the predicted movement of the living object to the driver assistance system at a further interface.

In some embodiments, the measurement data is at least one image of the at least one camera. That is, via the signal-transmitting interface, the device receives at least one image of at least one camera unit designed as a sensor unit. The advantage of this is that a picture is easy to create and can contain a lot of information; that is, a picture can easily capture many objects.

In some embodiments, the device is designed, upon acquisition of measurement data by more than one sensor unit, to merge the respective measurement data of the respective sensor unit into a common sentence of measurement data by fusion with the respective other measurement data of the respective other sensor units. For the monitoring of the living object, all available information of the living object as best as possible in existing fusion algorithms, such as Kalman filters or particle filters may be used. By means of the fusion, for example, by means of a Kalman filter, errors of different measurement data in the common set of fused measurement data can be kept as small as possible. Especially in multi-camera scenarios, this is advantageous to ensure the clear assignment, for example, of pedestrians in pedestrian groups.

In some embodiments, a driver assistance system which has the device as described herein and/or is designed to carry out the method as described herein is disclosed.

In some embodiments, a motor vehicle which has the device and/or the driver assistance system as described herein is disclosed.

The present disclosure also includes further embodiments of the device, the driver assistance system and the motor vehicle, which embodiments have features such as those previously described in connection with the further embodiments of the method as described herein. For this reason, the corresponding further embodiments of the device, the driver assistance system and the motor vehicle are not described again here. Furthermore, the present disclosure also includes developments of the method, the driver assistance system and the motor vehicle having the features as they have already been described in connection with the developments of the device as described herein with respect to various embodiments. For this reason, the corresponding further embodiments of the method, the driver assistance system and the motor vehicle are not described again here.

Exemplary embodiments of the present disclosure are described below. In the drawings:

The exemplary embodiments described below are preferred embodiments, the components of which constitute individual features to be considered both individually and in a combination that is different from the combination described. In addition, the embodiments described may also be supplemented by further features, which have already been described.

In the drawings, functionally identical elements are denoted with the same reference signs.

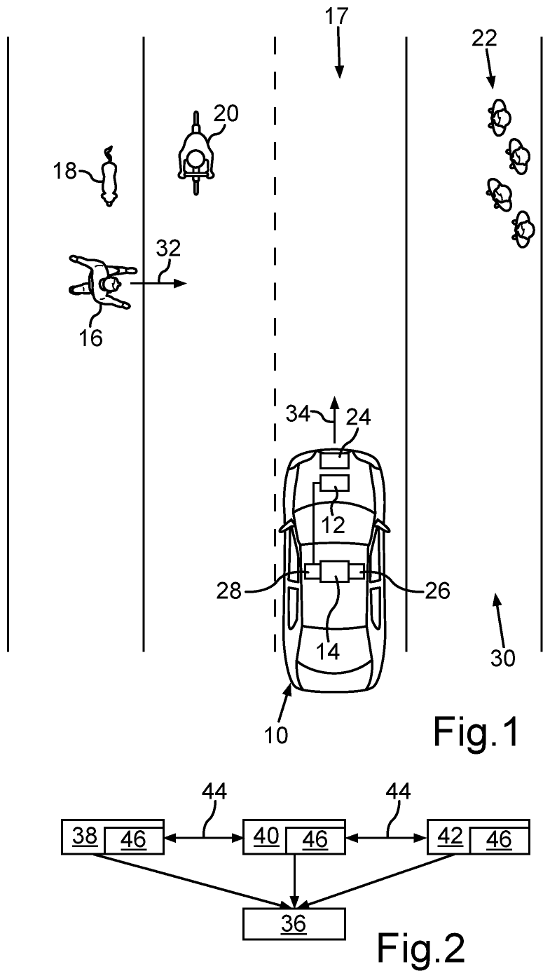

FIG. 1 shows a schematic plan view of a motor vehicle with a driver assistance system and a device, in accordance with some embodiments, in which the device can carry out the method as described herein, in the surroundings of the motor vehicle in which at least one living object and other objects are located. FIG. 1 shows a schematic plan view of a motor vehicle 10 with a driver assistance system 12 and a device 14. The device 14 is designed to perform a method by means of which the driver assistance system 12 of the motor vehicle 10 can be operated. In the method, a movement of at least one living object 16 in the surroundings 17 of the motor vehicle 10 is predicted. By means of the prediction, the driver assistance system can be operated particularly advantageously, since, for example, a collision with the living object 16 can be avoided. For this purpose, the device 14 is designed such that the at least one living object 16 and at least one other object 18, 20, 22 in the surroundings 17 of the motor vehicle 10 and their respective object position can be detected on the basis of measured data. The measurement data provided by at least one sensor unit 24 can be received by the device 14 at an interface 26.

In a step a) of the method, a motion model is stored, wherein a respective motion model describes a change of the movement of the living object 16 which is dependent on at least one other object 18, 20, 22, wherein the living object 16 and the at least one other object 18, 20, 22 each belong to an object class and the motion models for combinations of the object classes are stored.

For carrying out the step a), the device 14 is designed such that it has, for example, a memory device on which the motion models of the object classes or the combination of object classes are stored and/or the device can retrieve the stored motion models via a further interface. In a step b) of the method, measurement data relating to the surroundings 17 of the motor vehicle 10 are received; for this purpose, the device 14 has the interface 26. In a step c) of the method, the at least one living object 16 and the at least one other object 18, 20, 22 are recognized in the surroundings 17 of the motor vehicle 10 and a position of at least one living object is determined in relation to the at least one other object 18, 20, 22 based on the measurement data received via the interface 26. In addition, the positions of the other objects 18, 20, 22 in relation to one another and a respective object orientation of the objects 16 to 22 can likewise be detected or determined by means of the method. In a further step d) of the method, the object classes of the recognized objects 16, 18, 20, 22 are identified.

In a step e), which is subdivided into at least two sub-steps, for the detected living object 16 in the first sub-step, an equation of motion is developed at least as a function of the respective relative position of the living object 16 to the at least one other object 18, 20, 22. In addition, the equation of motion is dependent on the movement model stored in each case for the combination of the object classes of the living object 16 identified in step d) and the at least one other object 18, 20, 22. Furthermore, the respective orientations of the objects 16 to 22 can be incorporated into the equation of motion as an additional dependency. In the second sub-step of step e), a prediction of the movement of the living object 16 takes place on the basis of the developed equation of motion.

By way of non-limiting example, as shown in FIG. 1, the other object 18 is a dog, the object 20 is a cyclist and the object 22 is a group of people. The dog belongs to the object class “dog” and the cyclist belongs to the object class “cyclist.” The individual persons of the group of people can be assigned as a whole to the object class “group of people.” However, humans could also be assigned individually as an object of an object class “pedestrian” to which the living object 16 belongs. Also, their state could change between two measurement data recorded at a different point in time, for example, if the group of people dissolves.

In step f), the driver assistance system 12 is operated using the movement of the at least one living object 16, i.e. the pedestrian, predicted in step e), so that, for example, a collision with the pedestrian can be prevented by the driver assistance system 12 due to the motion predicted in the method.

The sensor unit 24 of the shown embodiment is formed as a camera. A plurality of sensor units 24 may be used to detect, for example, a larger portion of the surroundings 17 and/or to detect as much information as possible about the objects in the measurement data under adverse viewing conditions, for example, by using multiple cameras, each recording measuring data in different light spectra. When using multiple sensor units, the measurement data can be fused, for example by means of Kalman filter, for example, to keep errors in the measurement data low.

In accordance with some embodiments, in order for the individual steps a) to f) of the method to be carried out by the device 14, the latter has, for example, an electronic computing device on which an evaluation software for the measurement data received via the interface 26 can be executed, so that the objects to 22 are detected in the measured data and also their position and their object orientation in space or the surroundings of the vehicle are determined. In addition, by means of the electronic computing device, for example, a classifier can be executed, which takes over the determination or classification of the objects 16 to 22 into the object classes. In addition, the device 14 can have another interface 28, which can provide information about the predicted movement to the driver assistance system 12, so that it can be operated particularly safely, for example.

By way of non-limiting example, the living object 16, i.e., the pedestrian, is oriented in such a way that his/her viewing direction, which can be equated with the object orientation, is directed to a right sidewalk 30 of the surroundings 17. The object orientation is represented by the viewing direction 32. With this object orientation, the living object 16, i.e., the pedestrian, detects all the other objects 18 to 22 in the surroundings, i.e., the dog, the cyclist and the group of people. That is, one respective object of these objects 18 to 22 forms an information source for the pedestrian, the living object 16, by which source he/she can be influenced or distracted in his/her movement. If the sensor unit 24 detects this state of the surroundings 17 in the measurement data, in each case a motion model for the combination “pedestrian-dog,” “pedestrian-cyclist” and “pedestrian-group of people” is taken into account for the equation of motion.

Thus, for example, the motion model “pedestrian-dog” describes the reaction of a pedestrian to a dog, for example, the dog acting repulsively on a pedestrian. In other words, a repulsive force mediated by the dog acts on the pedestrian, in particular if, for example, a potential field approach based on a variant of the “social force model” is considered for the motion models. The dog, for example, has such an influence on the movement of the pedestrian that said pedestrian will keep a certain minimum distance to the dog. Thus, if the dog is at least near a route along which the pedestrian moves, the latter will correct his route and, for example, make an arc with at least the minimum distance around the dog before following the original route back to his destination. This minimum distance could be exceeded, for example, if the pedestrian is traveling at great speed and/or does not notice the dog in time. The respective motion model is advantageously designed so that such situations can be taken into account. If a dog is to be monitored as a living object and the influence of an object of the object class “pedestrian” on the dog is included in the equation of motion, a “dog-pedestrian” motion model should be stored.

In accordance with some embodiments, by way of non-limiting example, the respective motion models are described by a respective potential field. For example, a respective gradient of the potential field at the position of the pedestrian is determined from the respective potential field, for which purpose the relative positions can be used. That is, in the example shown, the positions in relation to the living object 16 are: “Pedestrian to dog,” “Pedestrian to cyclist” and “Pedestrian to groups of people.” From the respective gradient, a respective acceleration vector, which characterizes a respective part of the change of movement of the living object 16, can be determined. The respective certification vector is used in the equation of the movement for the prediction of the movement. Due to the method, an intuitive parameterization of a potential field approach to improve the monitoring of the movement of living objects, especially pedestrians, is possible.

The better the stored motion models and/or the measured data, the better the prediction of the movement of the living object 16. The motion models can be derived, for example, from the known “social force model” or from a similar model for describing pedestrian movements. Motion models can take into account subtleties, such as that a child in the proximity of at least one adult tends to move towards said adult, because it often happens to be at least one parent of the child.

In accordance with some embodiments, in order to improve the prediction of the movement, measurement data may be evaluated from distinguishable, successive points in time and the method to be repeated at each of these points of time using these measured data. Depending on the distance of the points of time, a quasi-continuous monitoring of the pedestrian, a so-called pedestrian tracking, is possible. In order to improve the accuracy of the prediction in such a continuous pedestrian tracking, a respective position of the respective recognized object can be controlled by means of the method based on an evaluation of the measured data. In addition, movements of the respective objects can be determined, for example, by differentiating temporally successive measurement data, from which a respective speed and/or acceleration and/or direction of movement of the respective object can be determined, which can be taken into account in the equation of motion. For example, at a first point in time, the dog may rest and thereby have little influence on the movement of the pedestrian, the living object 16. However, if the dog moves in the direction of the pedestrian, its influence becomes greater and this can be taken into account by the method.

In some embodiments, a map of the surroundings may be stored in the apparatus 14, aligned with the determined equation of motion. Thus, for example, if obstacles and/or objects of interest to the pedestrian, such as a cash machine, are detected on the card, this can be incorporated into the prediction of the movement by means of the equation of motion. Thus, in the example, the movement of the pedestrian can be determined independently of the knowledge of his actual destination, the right sidewalk 30. However, with the aid of map information, it is clear that the pedestrian, the living object 16, wants to cross the streets, which is deducible from the viewing direction 32. Thus, an intention of the pedestrian, that is, the goal that can be reached, can be better determined.

In accordance with some embodiments, by way of non-limiting example as shown in FIG. 1, when the path predicted for the living object 16 crosses the direction of travel 34 of the motor vehicle 10, the motor vehicle 10 itself is included as another object in the method.

The group of people, the other object 22, is an example that, if at least two other objects are detected and classified, a respective change of the respective movement of the respective other object is detected and considered in the equation of motion of the at least one living object 16 due to a mutual interaction between the at least two other objects, here the four pedestrians shown forming the group of people. In this case, the interaction is determined from the respective stored motion models and from the respective relative position. In other words, a plurality of pedestrians close to each other, such as in the group of people, can develop a common dynamic in their movement and are thus advantageously no more to be regarded as free-moving individual objects. By taking into account their mutual interaction, the equation of motion of the living object 16 thus improves. In the method shown, the following so-called framework conditions can be observed: a separation of dynamics and information sources; a parameterization of dynamics and information sources relative to the intention of the living object; use of the findings of the “social force model” in the definition of the individual potential fields. Thus, for example, very few intuitive parameters can result.

FIG. 2 shows a schematic diagram of an interaction of individual components of the method in a monitoring of the living object, in accordance with some embodiments. FIG. 2 shows a schematic diagram of an interaction of individual components of the method for monitoring the living object 16. In this case, the monitoring, the so-called tracking 36, takes place for example, based on map information 38, an intention 40 of the living object 16 and the, in particular dynamic, other objects, such as the objects 18, 20 and 22, which are summarized in the block 42. Dynamic objects may be pedestrians, dogs, cyclists and/or motor vehicles. Furthermore, instead of dynamic objects, semi-static objects such as mobile traffic lights and/or static objects such as a telephone booth or the like could be taken into account in the method. From the intention 40 of the living object 16 whose movement is derivable, this has a dynamic 44. For example, the dynamics of a pedestrian can describe the maximum achievable speed and/or deceleration and/or its speed when changing the direction. This information is advantageously stored in the respective motion model, which describes an influence on the change of the movement of the living object 16 due to another object from block 42. In order to be able to determine the equation of motion of the pedestrian as simply as possible, a parameterization of, for example, the map information 38 and/or the other objects combined in block 42 takes place in each case. The parameterization is indicated by the arrows 44 and should represent their possible, respective independence of the respective parameters. Furthermore, the map information 38 as well as the objects of the block 42 may each have their own dynamics 46. Such dynamics 46 may be, for example, in the case of the map information 38, real-time information of the traffic situation, whereby, for example, road closures can be taken into account.

Overall, the examples show how the present disclosure provides a method and/or a device 14 and/or a driver assistance system 12 and/or a motor vehicle 10 by means of which respectively a movement of at least one living object 16 is predicted, whereby the driver assistance system 12 can be operated by including this prediction.

1.-13. (canceled)

14. A method for operating a driver assistance system of a motor vehicle, comprising:
storing a plurality of motion models, wherein a motion model of the plurality of motion models describes a change of the movement of a living object that is dependent on at least one other object, wherein the living object and the at least one other object belong to an object class of a plurality of object classes, and wherein the plurality of motion models correspond with a plurality of combinations of the plurality of object classes;
receiving measurement data relating to surroundings of the motor vehicle;
based on the received measurement data, recognizing the living object and the at least one other object in the surroundings of the motor vehicle;
determining a position of the living object and the at least one other object in relation to each other based on the received measurement data;
identifying a first object class associated with the recognized living object and a second object class associated with the recognized at least one other object;
based on the position of the living object determined in relation to the position of the at least one other object, and based on the motion model of the plurality of motion models that corresponds with the first object class and the second object class, developing an equation of motion of the living object;
predicting a movement of the living object based on the equation of motion; and
operating the driver assistance system taking into account the predicted movement of the living object.

15. The method of claim 14, wherein the developing the equation of motion further comprises taking into account respective object orientations of the living object and the at least one other object in the surroundings of the motor vehicle.

16. The method of claim 14, wherein the developing the equation of motion further comprising developing the equation of motion as a function of a direction of movement of the living object, speed of the living object, acceleration of the living object and/or of the at least one other object, wherein measured data from positions of the living object and the at least one other object determined at a first time are compared with positions determined from measurement data at at least one further point in time, whereby a the direction of movement, the speed, the acceleration of the living object and/or of the at least one other object is determined.

17. The method of claim 14, wherein the motion model is associated with a potential field.

18. The method of claim 14, wherein the developing the equation of motion further comprises forming a gradient based on a potential field; and
developing the equation of motion as a function of the gradient.

19. The method of claim 14, further comprising:
comparing the equation of motion with a map of the surroundings of the motor vehicle; and
in response to the predicted movement of the living object being recognized as not executable based on the comparison, correcting the equation of motion and the predicted movement according to the map of the surroundings of the motor vehicle.

20. The method of claim 14, further comprising:
in an event that at least two other objects are detected and classified, determining a change in movement of the at least two other objects according to a mutual interaction between the at least two other objects; and
wherein the developing the equation of motion of the living object further includes considering the mutual interaction between the at least two other objects,
wherein the mutual interaction is determined based on the motion model and the position of the living object and the at least two other objects in relation to each other.

21. The method of claim 14, wherein the at least one other object is the motor vehicle.

22. A device for operating a driver assistance system of a motor vehicle, the device comprising:
a memory;
a first interface that communicatively couples the device associated with the driver assistance system with at least one sensor unit; and
a second interface that communicatively couples the device with the driver assistance system,
wherein the device is configured to perform operations comprising:
detecting a living object and at least one other object in surroundings of the motor vehicle and object positions of the living object and the at least one other object based on measurement data generated by the at least one sensor unit and acquired at the first interface,
determining a first object class for the living object and a second object class for the at least one other object,
storing a motion model corresponding to a combination of the first object class of the living object and the second object class of the at least one other object in the memory, wherein the motion model describes a change of movement of the living object that is dependent on the at least one other object,
developing an equation of motion of the living object as a function of at least the combination of the first object class and the second object class, position of the living object determined in relation to position of the at least one other object associated with the motion model,
predicting a movement of the living object based on the equation of motion, and
providing data describing the predicted movement of the living object to the driver assistance system over the second interface.

23. The device of claim 22, wherein the measurement data is at least one image of at least one camera.

24. The device of claim 22, wherein the operations further comprise merging measurement data received from more than one sensor units into the measurement data.

25. A driver assistance system, comprising:
a device that is configured to perform operations comprising:
storing a plurality of motion models, wherein a motion model of the plurality of motion models describes a change of the movement of a living object that is dependent on at least one other object, wherein the living object and the at least one other object belong to an object class of a plurality of object classes, and wherein the plurality of motion models correspond with a plurality of combinations of the plurality of object classes;
receiving measurement data relating to surroundings of the motor vehicle;
based on the received measurement data, recognizing the living object and the at least one other object in the surroundings of the motor vehicle;
determining a position of the living object and the at least one other object in relation to each other based on the received measurement data;
identifying a first object class associated with the recognized living object and a second object class associated with the recognized at least one other object;
based on the position of the living object determined in relation to the position of the at least one other object, and based on the motion model of the plurality of motion models that corresponds with the first object class and the second object class, developing an equation of motion of the living object;
predicting a movement of the living object based on the equation of motion; and
operating the driver assistance system taking into account the predicted movement of the living object.

26. A motor vehicle comprising a driver assistance system, wherein the driver assistance system comprises a device configured to perform operations comprising:
storing a plurality of motion models, wherein a motion model of the plurality of motion models describes a change of the movement of a living object that is dependent on at least one other object, wherein the living object and the at least one other object belong to an object class of a plurality of object classes, and wherein the plurality of motion models correspond with a plurality of combinations of the plurality of object classes;
receiving measurement data relating to surroundings of the motor vehicle;
based on the received measurement data, recognizing the living object and the at least one other object in the surroundings of the motor vehicle;
determining a position of the living object and the at least one other object in relation to each other based on the received measurement data;
identifying a first object class associated with the recognized living object and a second object class associated with the recognized at least one other object;
based on the position of the living object determined in relation to the position of the at least one other object, and based on the motion model of the plurality of motion models that corresponds with the first object class and the second object class, developing an equation of motion of the living object;
predicting a movement of the living object based on the equation of motion; and
operating the driver assistance system taking into account the predicted movement of the living object.
